(19) United States
(12) Patent Application Publication
(10) Pub. No.: US 2014/0164074 A1
(43) Pub. Date: Jun. 12, 2014

(54) ONLINE VOTING SYSTEMS AND METHODS

(71) Applicant: Milton Theo, Potomac, MD (US)

(72) Inventor: Milton Theo, Potomac, MD (US)

(21) Appl. No.: 14/099,091

(22) Filed: Dec. 6, 2013

Related U.S. Application Data
(60) Provisional application No. 61/736,077, filed on Dec. 12, 2012.

(51) Int. Cl. G06Q 99/00

(52) U.S. Cl. CPC G06Q 99/00
USPC 705/12

(57) ABSTRACT

Embodiments described herein attempt to provide a resolution mechanism to people who believe they have a lawful grievance against another, so that a person can bring a claim with any of the complications associated with going to court. Embodiments attempt to avoid the use of the courts, avoid the need for lawyers, and allow a worldwide pool of voters to submit votes rather than relying upon a pre-selected jury. If a person believes that he/she has a claim against another person, he/she can bring an action. The system can more efficiently render a verdict based upon basic issues, the facts, the genuineness of the claim, and fairness of the award. During registration, the parties agree to the terms and conditions for participating in the process. One of the terms is may be agreement that the majority vote of the website will be binding upon each of them, and that neither will bring the issue to a court, mediation, or alternative dispute resolution.

### CROSS-REFERENCE TO RELATED APPLICATIONS

This application claims priority to U.S. Provisional Patent Application Ser. No. 61/736,077, filed Dec. 12, 2012, entitled ONLINE VOTING SYSTEMS AND METHODS, which is hereby incorporated by reference in its entirety.

### FIELD OF THE INVENTION

This invention relates generally to the use of an online voting system.

### BACKGROUND

The legal systems in many countries of the world do not afford access to the man in the street or the owner or manager of a small business. Many people who are involved in matters or transactions that suffer damages or other harm either do not have the wherewithal or the finances to assert their rights through the local courts of their countries. Many people believe that the law only serves the rich and is not available to the middle or lower classes. It is desirable to provide resolution for these matters to any individual or business.

### SUMMARY

The systems and methods described herein attempt to overcome the deficiencies of the conventional solutions. The systems and methods described herein attempt to provide a resolution mechanism to people who genuinely believe they have a lawful grievance against another, so that a person can bring a claim against another person in the most expeditious way possible without any of the complications associated with going to court. The systems and methods attempt to avoid the use of the courts, avoid the need for lawyers, and allow a worldwide pool of voters to submit votes rather than relying upon a small, hand-picked or otherwise selected jury. As a result, if a person believes that he/she has a claim against another person for monetary compensation, that person can bring an action on the website described herein. The person having the claim may desire to utilize a system that can more efficiently render a verdict based upon basic issues, the facts of the case, the genuineness of the claim, and fairness of the award. In a registration process on the website, a plaintiff and a defendant will agree to the terms and conditions for participating in the process. One of the terms may be agreement that the majority vote of the website will be binding upon each of them, and that neither will bring the issue to a court, mediation, or alternative dispute resolution, other than for the enforcement of the award against the loser. By agreeing to be bound by the verdict of a majority of voters, the successful party (who receives the majority of votes in their favor) is afforded an opportunity to bring a claim in a court of law for the enforcement of the decision based on such an agreement.

In one embodiment, a computer-implemented method for resolving a dispute comprises receiving, by a server, a submission from a computing device of a first party, wherein the submission comprises a claim against a second party and an award request; receiving, by the server, a submission from a computing device of the second party, wherein the submission comprises a response to the claim and the award request; presenting, by the server, a website comprising the submission from the first party and the submission from the second party; receiving, by the server, a plurality of votes from a plurality of voters from a set of voters in favor of either the first party or the second party, wherein the set of voters comprises all users of the website and the plurality of voters are not pre-selected from the plurality of voters, and the plurality of voters are not limited to a predetermined number of voters; and compiling, by the server, the plurality of votes to determine whether the first party or the second party won the vote.

In another embodiment, a system for resolving a dispute comprises a server configured to present a website for rendering on a browser of a computing device, wherein the website displays a claim of a first party, a response of a second party, a link for selection to vote for the first party, and a link for selection to vote for the second party, wherein the server is further configured to present the website to a set of users of the website, wherein the set of users is not limited to a predetermined number of users and the users are not pre-selected.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates a system overview according to an exemplary embodiment.

FIG. 2 illustrates a graphical user interface according to an exemplary embodiment.

FIG. 3 illustrates a graphical user interface according to an exemplary embodiment.

### DETAILED DESCRIPTION

Various embodiments and aspects of the invention will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present invention.

In most jurisdictions of the civilized world, the law is intended to protect the rights of their citizens and to see that justice is done. Unfortunately, the resolution of issues often requires significant financial means. The systems and methods described herein attempt to provide a solution that allows people to resolve their issues in an efficient and low cost manner.

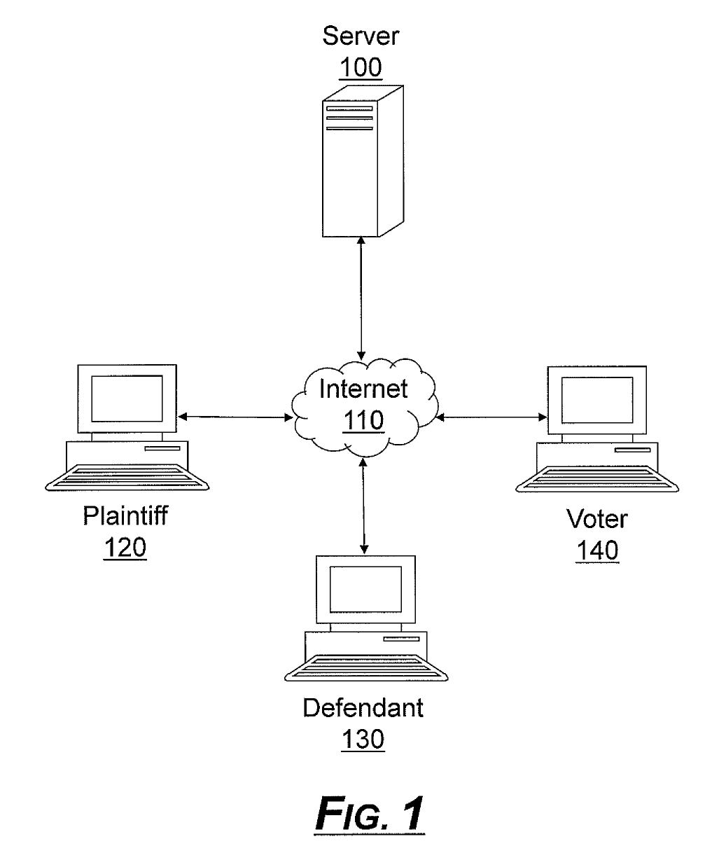

Referring to FIG. 1, a system overview is shown according to an exemplary embodiment. A server 100 hosts a website, which in this exemplary embodiment, can be called “Consider Your Verdict” or “World Wide Jury.” The website can be accessed over a network 110 (e.g., the internet) by a computing device of a user. The server 100 may include one or more servers or databases for hosting the website, processing information, and storing information. In an exemplary embodiment, the server 100 is a web server that hosts the website. The web server may be communicatively coupled to a database that stores records of information about voters, plaintiffs, defendants, resolved disputes, pending disputes, votes, registration information, enrollment information, or other information processed by the web site. The web server may also communicate with another server that processes information from the database and presents the information to the web server for rendering in a browser of a computing device viewing the website.

A plaintiff 120 can be a complainant, claimant, or other party who accesses the website hosted by the server 100 to register, file, serve, or submit a complaint about an issue or harm caused to the plaintiff, possibly resulting in monetary loss or damages by the plaintiff. The issue or harm should involve a civil issue, rather than a criminal prosecution, which is more appropriately handled in a court of law. A civil action is a process whereby an injured party seeks to get restitution for damages that he or she has incurred as a result of a wrongful act by another party. Civil actions can include claims for damages actually suffered by the injured party as a result of the wrongful act or omission. Wrongful acts can be any negligent, or willful act that causes damage to another. The plaintiff 120 can be a person or a corporation. The plaintiff 120 can access the website via a networked computing device, such as a personal computer, tablet computer, mobile phone, smart phone, or a gaming console.

A defendant 130 is accused by the plaintiff 120 of causing harm to the plaintiff 120. The defendant 130 can be a person or a corporation. The defendant 130 can access the website via a networked computing device, such as a personal computer, tablet computer, mobile phone, smart phone, or a gaming console.

A voter 140 is a person that can access the website hosted by the server 100 and submit a vote on an outcome of the dispute between the plaintiff 120 and the defendant 130. The voter 140 can access the website via a networked computing device, such as a personal computer, tablet computer, mobile phone, smart phone, or a gaming console. The voter 140 can comprise any individual over 18 years old.

The voter 140 can be selected from a set of voters. The set of voters includes all individuals that can access the website. There is no restriction on the number of voters. The plaintiff 120 and the defendant 130 do not choose the voters, but rather all voters may cast a ballot regarding any issue presented on the website. In some conventional dispute resolution systems, a plaintiff or defendant may select a jury, a judge, or a mediator. In the systems and methods described herein, however, any user of the website may be a voter on any issue.

The system may impose some limitations on who can access the website. For example, the system may require that each voter is at least 18 years old. The system may also require that the voter is capable of proving that the voter is human. The system may verify age and whether the voter is human by requiring identification, requiring authentication or verification mechanisms that prevent bots from voting on the website, and by requiring registration of voters before voting. In one example, the voter may enter a drivers license, state identification, country identification, or passport number in order to cast a vote. In another example, the user may be required to enter a phrase or alphanumeric characters that cannot be read by a bot using optical character recognition. In another example, the voter may register or enroll with the website and provide identification credentials during the registration or enrollment process. In another example, the system may allow only one vote per IP address in an attempt to prevent multiple votes from a single computing device. In another example, the system may allow only one vote per email address, where each email address must be submitted with the vote or as a part of registration or enrollment.

The plaintiff 120 accesses a web page on the computing device of the plaintiff 120 that was presented for display by the server 100. The server 100 presents a web page that has a form for completion by the plaintiff 120. The form includes at least the following elements: name of the plaintiff 120, mailing address of the plaintiff 120, email address of the plaintiff 120, name of the defendant 130, mailing address of the defendant 130, email address of the defendant 130, a description of the issue (e.g., a reason for the claim) and the damages sought (e.g., dollar amount) by the plaintiff 120, and any documents upon which the plaintiff 120 relies upon for proving the claim.

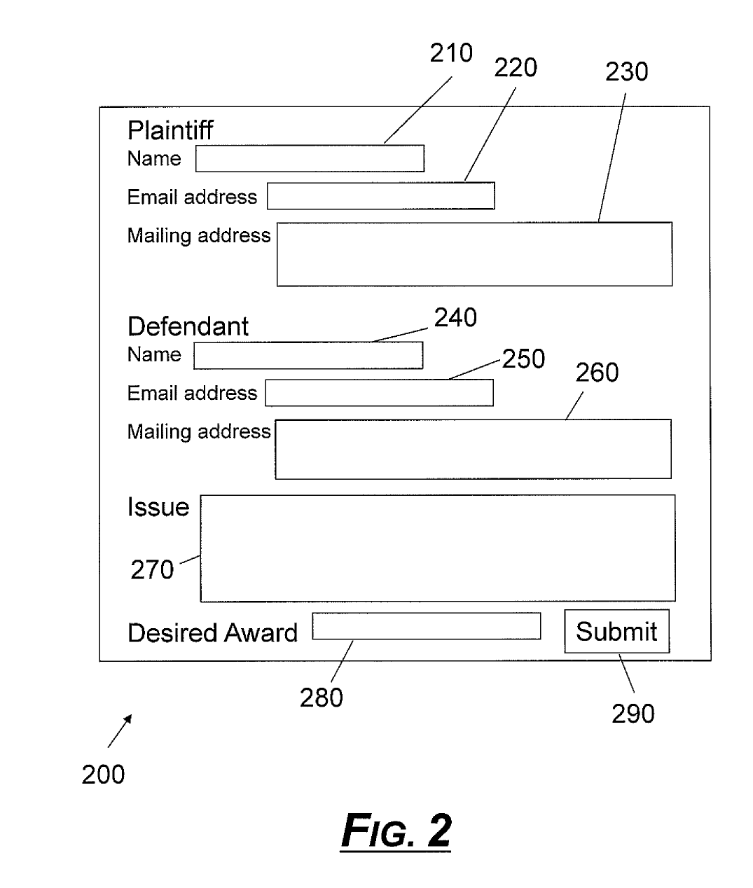

Referring to FIG. 2, a graphical user interface 200 is shown according to an exemplary embodiment. This graphical user interface 200 can be generated by the server and presented on a browser of a computing device of a plaintiff attempting to submit a new claim. In this exemplary embodiment, the graphical user interface has fields for name of plaintiff 210, email address of plaintiff 220, mailing address of plaintiff 230, name of defendant 240, email address of defendant 250, mailing address of defendant 260, issue 270, and desired award 280. When this form is submitted, the plaintiff can select with the “submit” button 290 for processing by the server.

The graphical user interface may prompt the plaintiff to enter any or all of the information about the parties, including but not limited to: plaintiff's first or given name, plaintiff's middle name, plaintiff's family or surname, plaintiff's postal address, plaintiff's physical address, plaintiff's e-mail address, plaintiff's telephone number, defendant's first or given name, defendant's middle name, defendant's family or surname, defendant's postal address, defendant's physical address, defendant's e-mail address, and defendant's telephone number. The plaintiff can then select a type of claim from a drop down menu or other selection mechanism. The type of claim can include, but is not limited to: debt for the sale of goods, debt for services rendered, arrear salary/wages, repayment of loan, damages for personal injury, arrear maintenance, arrear child support, damages for unlawful dismissal, damages for assault and battery, damages for libel/slander, damages for negligence, and royalties for copyright. The plaintiff will also be prompted to input an amount of the claim, a date of claim, whether the claim has been tried in any civil court, whether the defendant paid any amount to you on account of this claim (and the date and amount if the defendant made a payment), copies of any documents related to this matter, and any witness to prove this claim.

In one embodiment, the web page can guide the plaintiff 120 using a wizard or an automated system for prompting for required information. For example, after prompting for the plaintiff's contact information, the automated system can prompt the plaintiff 120 to enter the defendant's contact information. If there is information missing or is entered improperly, the automated system can alert the plaintiff 120 before proceeding to the next step.

Upon submission of these elements by the plaintiff 120, the server will store the responses in the server 100 or an associated database. The server 100 will then present a web page of terms and conditions for use of the system for acceptance by the plaintiff 120. The plaintiff 120 can respond with an acknowledgement or acceptance of the terms and conditions, which allows the server 100 to proceed to the next step. The server 100 will store an indicator that the plaintiff 120 acknowledged or accepted the terms and conditions.

The server 100 will generate an email based on the form submitted by the plaintiff 120. The server 100 will then transmit the email to the defendant 130 using the email address of the defendant 130 provided by the plaintiff 120.

The defendant 130 has two choices. First, the defendant 130 can respond to the claim in the email. Second, the defendant 130 can ignore the claim and the email.

In the first option, if the defendant 130 desires to respond to the claim and defend himself/herself/itself, the defendant 130 will first acknowledge or accept the terms and conditions presented by the server 100. One condition is that the defendant 130 will abide by and submit payment for any award associated with the decision of the website. Another condition is that both party are expected to comply with the decision delivered by the website, and the parties will submit to a jurisdiction of the appropriate court in the area of his/her/its residence for enforcement of the decision. If the plaintiff 120 gets a decision in his/her/its favor, and the defendant 130 fails to pay the amount of an award due to the plaintiff 120, then the conditions may specify that the only recourse that the plaintiff 120 will have will be to seek justice from a court of law in the jurisdiction.

In the second option, if the defendant 130 decides not to do anything about the claim, then the defendant 130 is free to ignore the claim, thereby ending the matter with respect to the website. The plaintiff 120 may still be able to pursue the claim for resolution by a judge, arbitrator, or mediator.

The website may have a few other conditions to prevent conflicts. For example, the website will not handle claims that have already been referred to a court. However, the website may allow a decision based on a court's judgment, where that judgment has not been appealed to an appellate court. In another example, the website will not allow two actions for the same claim at the same time.

When the defendant 130 responds to the claim, the defendant may also submit a counterclaim against the plaintiff 120 for consideration on the website. The counterclaim is subject to the same terms and conditions as the plaintiff's claim.

The website may limit the claims to only those with a legal justification. Alternatively, the website may consider claims that do not have a legal justification, or might even exclude those claims that have a legal justification. The server 100 may ascertain whether there is a legal justification based upon a keyword search of the claim, e.g., identifying the terms “contract” and “breach” may suggest a legal justification. In one embodiment, the server 100 can transmit a claim to an administrator of the website to assist in determining whether a claim has a legal justification. The determination of a legal justification is not a decision on the matter at this stage, but rather an initial cursory review of the claim. If the claim is clearly unfounded in law, the server 100 will inform the plaintiff 120 (or inform the defendant 130 if the counterclaim is clearly unfounded in law) by generating and transmitting a message to that effect.

If the plaintiff receives a message that the claim is unfounded in law on its face, the plaintiff 120 can revise and resubmit the claim. The revised claim will undergo the same scrutiny by the server 100 as the original claim. The server 100 will not assist in advising the plaintiff on how to revise the claim. Likewise, any defense or counterclaim submitted by the defendant 130 will be subject to the same scrutiny and available for revision if necessary.

If the defendant 130 submits a defense that is untenable, i.e., not defendable because it lacks qualities such as sound reasoning or high moral ground that make a defense possible, then the server 100 will generate and transmit a message to the defendant 130 to that effect. The server 100 will analyze the defense using the same scrutiny and process as used to determine whether claims have a legal justification.

If the defendant 130 responds that he/she/it will defend the claim and acknowledges or accepts the terms and conditions, the defendant 130 has a predetermined period of time (e.g., 21 days) to respond with a defense. Within that time period, the defendant can log onto the website and submit a defense, which is stored by the server 100 or an associated database and linked to the record of this particular claim.

The server 100 generates a webpage based upon the claim by the plaintiff 120, the defense by the defendant 130, any counterclaim by the defendant 130, any response to the counterclaim by the plaintiff 120, and any documents provided by the plaintiff 120 or defendant 130 in support of their case. The web page is then published on the website hosted by the server 100 for a predetermined period of time (e.g., 1 month). The web page will make it apparent to the voters 140 how much time remains, such as by using a countdown clock. The web page can also present a real time percentage (e.g., 40% for plaintiff and 60% for defendant) or tally (e.g., 1000 votes in favor of plaintiff and 1500 votes in favor of defendant) of the voting in progress. In one embodiment, in order to prevent the voting data from persuading a voter, the percentage or tally is not shown until after the voter submits a vote. Anyone in the public can vote for a decision on the claim from a computing device networked to the server 100. In one embodiment, the public can include any individual in the world with access to the website, but the public may also be limited to a particular jurisdiction based upon an IP address or other identifier. The server 100 can present a field for the voter 140 to enter comments or an amount of an award. In one embodiment, the server 100 can present multiple choices for selection, including no award, a full award, and portions of the award. Each voter 140 can submit a vote over the internet 110 to the server 100 with a decision (in favor of or against the plaintiff or defendant), judgment, award, critique, or other comments. After submitting a vote, the server 100 can present other cases to the voter in which the voter might like to vote. The server 100 can also generate and send update messages to the plaintiff 120, defendant 130, and voters 140 (for claims in which they have voted) regarding the status and updated voting results of a pending claim.

The server 100 can use an internal web spider to extrapolate the most relevant information from each claim. The relevant information can be provided to the voters 140 to assist in making a decision. The server 100 can present this information on a separate page (e.g., a summary web page) or along with the claim.

The server 100 can present a web page to the voters 140 with a graphical user interface that presents a listing of the claims that are available for voting. The claims can be listed in chronological order or may be categorized, e.g., alimony or marriage disputes, debt collection, personal injury. Each voter 140 can choose the category that appears most interesting. The claims can be assigned to categories based upon keywords that appear in the claim, or the plaintiff 120 can choose a category when submitting the claim.

In one embodiment, each of the plaintiff 120 and defendant 130 can submit a video where that party presents their own case. These videos can be stored by the server 100 and viewed by a voter 140 along with the claim and any documents. Alternatively, a virtual hearing can be conducted, whereby the plaintiff 120 and defendant 130 each use a webcam to attend a virtual hearing with a host. Although the host will have the role of a judge, the host will not offer any judgment and will merely moderate the case between the parties. The virtual hearing can be offered live to the voters 140 or may be recorded and later viewed by the voters 140.

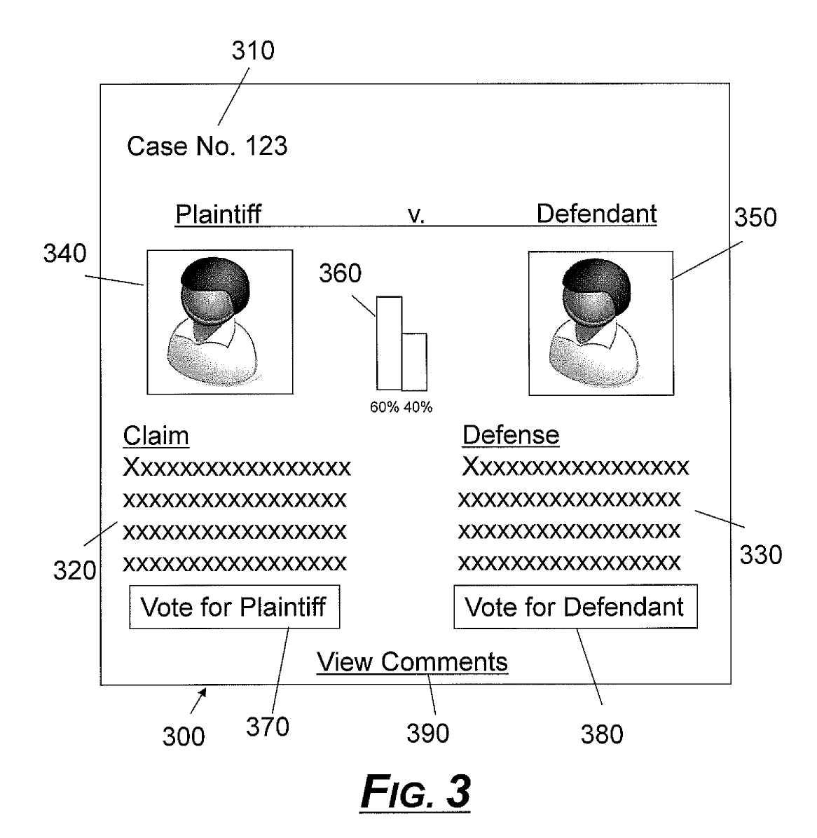

Referring to FIG. 3, a graphical user interface 300 is shown according to an exemplary embodiment. This graphical user interface 300 can be generated by the server and presented on a browser of a computing device of a voter attempting to vote on a claim. The graphical user interface 300 can present a case number 310 or other identifier of the claim, a description of the claim 320, a description of the defense 330, a video or other multimedia of the plaintiff's argument or evidence 340, a video or other multimedia of the defendant's argument or evidence 350, and up-to-date voting results 360 shown in this exemplary embodiment as percentages. The voter can select a “Vote for Plaintiff” button 370 or a “Vote for Defendant” button 380. The voter can also choose to a link to “View Comments” 390 before or after voting to see how other voters commented or discussed this particular issue. Upon selection of this link, a new window may be presented with those comments.

The server 100 will determine the winner based on a majority of votes cast by the voters 140. The website will not render a decision of its own or issue any comment, but will present a web page with the decision of the majority of voters 140 and the voting results. The website may present a web page with the issues arising in each case to generate additional comments and feedback from voters 140. The voters 140 can also communicate with other voters through comments or chat functionality. In an alternative embodiment, a voter 140 may even change a submitted vote if desired, which may occur after persuasive comments from other voters. Voters 140 may be given a predetermined or limited amount of time to submit a vote to allow for expeditious treatment of disputes. In one embodiment, the claim may be presented on the website for a predetermined period of time before votes are accepted by the website. Details about voter demographics and identification of voters may not be released to the plaintiff 120 and defendant 130. Voters 140 will be subject to authorization of age and identity before submitting comments or a vote.

In the exemplary embodiment, each voter 140 will be limited to a single vote. The votes can be restricted based upon an IP address of the voter 140 or a number being allotted to the voter 140. Because the voter 140 may have various computing devices, the server 100 may also request other identifying information (e.g., name, phone number, address, email address) to ensure that the voter 140 is submitting only one vote.

If the majority (e.g., 50%, ⅔, or other percentage over 50%) vote favors the plaintiff 120, and the decision requires that the defendant 130 make a payment to the plaintiff 120, then the server 100 may coordinate the payment from the defendant 130 to the plaintiff 120. In one embodiment, the server 100 may prompt the defendant 130 to make a payment to the plaintiff 120 and ask that either party confirm when the payment has been made. In another embodiment, the defendant can make a payment using the server 100, whereby the defendant 130 pays the website, and the website then provides a payment to the plaintiff 120. In the payment from the website to the plaintiff 120, the website may deduct a fee for administrative costs or as a basis of the website's revenue. In yet another embodiment, the server 100 can utilize a person-to-person payment system that allows the defendant 130 to pay the plaintiff 120. In another embodiment, the defendant 130 may make a payment to the plaintiff 120, and the payment is held in an escrow account until completion of the vote, whereby it is returned to the defendant 130 if the defendant prevails or provided to the plaintiff 120 if the plaintiff prevails.

The functionality described herein can be implemented by numerous modules or components that can perform one or multiple functions. Each module or component can be executed by a computer, such as a server, having a non-transitory computer-readable medium and processor. In one alternative, multiple computers may be necessary to implement the functionality of one module or component.

Unless specifically stated otherwise as apparent from the following discussion, it is appreciated that throughout the description, discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The exemplary embodiments can relate to an apparatus for performing one or more of the functions described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a bus or other communication device.

The exemplary embodiments described herein are described as software executed on at least one server, though it is understood that embodiments can be configured in other ways and retain functionality. The embodiments can be implemented on known devices such as a personal computer, a special purpose computer, cellular telephone, personal digital assistant (“PDA”), a digital camera, a digital tablet, an electronic gaming system, a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing the processes described herein can be used to implement the systems and techniques according to this invention.

It is to be appreciated that the various components of the technology can be located at distant portions of a distributed network and/or the Internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

The embodiments described above are intended to be exemplary. One skilled in the art recognizes that there are numerous alternative components and embodiments that may be substituted for or included in the particular examples described herein and such additions or substitutions still fall within the scope of the invention.

What is claimed is:

1. A computer-implemented method for resolving a dispute, the method comprising:
receiving, by a server, a submission from a computing device of a first party, wherein the submission comprises a claim against a second party and an award request;
receiving, by the server, a submission from a computing device of the second party, wherein the submission comprises a response to the claim and the award request;
presenting, by the server, a website comprising the submission from the first party and the submission from the second party;
receiving, by the server, a plurality of votes from a plurality of voters from a set of voters in favor of either the first party or the second party, wherein the set of voters comprises all users of the website and the plurality of voters are not pre-selected from the plurality of voters, and the plurality of voters are not limited to a predetermined number of voters; and
compiling, by the server, the plurality of votes to determine whether the first party or the second party won the vote.

2. The method according to claim 1, further comprising registering, by the server, each of the plurality of voters.

3. The method according to claim 1, further comprising receiving, by the server, identification information from each of the plurality of voters.

4. The method according to claim 1, further comprising presenting, by the server, a verification request that is configured to be answerable by a human being.

5. The method according to claim 1, further comprising, requesting, by the server, evidence that each voter is a human being.

6. The method, according to claim 1, further comprising displaying, by the server, the submission from the first party and the submission from the second party on the website for a predetermined period of time.

7. The method according to claim 6, further comprising receiving, by the server, the plurality of votes from the plurality of voters during the predetermined period of time.

8. The method according to claim 1, further comprising dynamically displaying, by the server, a number of votes in favor of the first and second parties on the website.

9. The method according to claim 1, further comprising receiving, by the server, a payment from the second party to the first party upon the first party receiving a majority of votes in a predetermined period of time.

10. The method according to claim 9, further comprising holding, by the server, the payment in escrow until the completion of the vote.

11. A system for resolving a dispute, the system comprising:
a server configured to present a website for rendering on a browser of a computing device, wherein the website displays a claim of a first party, a response of a second party, a link for selection to vote for the first party, and a link for selection to vote for the second party, wherein the server is further configured to present the website to a set of users of the website, wherein the set of users is not limited to a predetermined number of users and the users are not pre-selected.

12. The system according to claim 11, wherein the server is further configured to present a dynamic display of votes received.

13. The system according to claim 11, further comprising a database storing a record for each user in the set of users, wherein each user is registered with the system to cast a vote on the website.

14. The system according to claim 13, wherein each record further comprises identification information of the user.

15. The system according to claim 14, wherein the identification information is selected from the group consisting of: a drivers license number, a state identification number, a country identification number, a passport number, an IP address, and an email address.

16. The system according to claim 11, wherein the server is further configured to request evidence that each voter is a human being.

17. The system according to claim 11, wherein the server is further configured to receive a payment from the second party and transfer the payment to the first party when the first party prevails in the vote.

18. The system according to claim 17, wherein the server is further configured to hold the payment in escrow during the vote.
